(19) United States
(12) Patent Application Publication
(10) Pub. No.: US 2009/0165309 A1
(43) Pub. Date: Jul. 2, 2009

(54) Utility knife with blade release machanism

(75) Inventors: William Kamb, Coconut Creek, FL (US); Glenn Robinson, Coral Springs, FL (US)

Correspondence Address: Dan M. DeLaRosa, Esq., 300 E 77th Street, Suite 24C, New York, NY, 10075, US

(73) Assignee: IBT Holding, LLC

(21) Appl. No.: 12/005,521

(22) Filed: Dec. 27, 2007

(51) Int. Cl. B26B 1/04; B26B 1/10; B26B 3/06

(52) U.S. Cl. 30/161; 30/125; 30/162

(57) ABSTRACT

A folding utility knife with a blade release mechanism is provided, and the knife comprises: a handle comprising at least two side walls forming an internal space; a blade holding compartment pivotally connected to the handle, and the blade holding compartment comprises at least two side walls forming an internal blade cavity for holding a blade, at least a portion of the blade holding compartment is designed to be situated within the space of the handle during a folded position; and a blade release device comprises a blade lock and a button wedge, and the blade lock comprises at least one indentation situated in between at least two protrusions, and the protrusions are designed to contact and secure the blade within the blade cavity of the blade holding compartment, and the button wedge comprises a button connected to a wedge, and the wedge is designed to be situated within and moveable about a space created by the indentation of the blade lock, and the button is designed to be slidably moved to allow the wedge to engage the blade lock and create space between the blade and the protrusions of the blade lock to thereby release the blade.

### BACKGROUND OF THE INVENTION

1. Field of the Invention

This invention relates to a folding utility knife and more specifically, to a utility knife with a blade release mechanism. The present invention provides for a folding utility knife which comprises: a handle comprising at least two side walls forming an internal space; a blade holding compartment pivotally connected to the handle, and the blade holding compartment comprises at least two side walls forming an internal blade cavity for holding a blade, at least a portion of the blade holding compartment is designed to be situated within the space of the handle during a folded position; and a blade release device comprises a blade lock and a button wedge, and the blade lock comprises at least one indentation situated in between at least two protrusions, and the protrusions are designed to contact and secure the blade within the blade cavity of the blade holding compartment, and the button wedge comprises a button connected to a wedge, and the wedge is designed to be situated within and moveable about a space created by the indentation of the blade lock, and the button is designed to be slidably moved to allow the wedge to engage the blade lock and create space between the blade and the protrusions of the blade lock to thereby release the blade.

2. Description of the Related Art

There are various patents covering folding utility knife type devices. These patents cover folding utility knives that have blade holding compartments such as U.S. Pat. No. 6,688,003 to Scarla, U.S. Pat. No. 6,354,007 to Scarla, U.S. Pat. No. 6,968,622 to Ping, 7,007,392 to Ping, U.S. Pat. No. 7,040,022 to Ping and U.S. Pat. No. 7,134,207 to Ping. These patents do not provide for any easy mechanism for releasing the blade and do not provide a way to effective remove and replace the blade.

The present invention provides for folding utility knives with a new and improved folding mechanism and a new and improved blade release mechanism. The present invention overcomes numerous problems presented by the prior art.

### SUMMARY OF THE INVENTION

In one embodiment, the present invention provides for a folding utility knife, the knife comprises: a handle comprising at least two side walls forming an internal space; a blade holding compartment pivotally connected to the handle, and the blade holding compartment comprises at least two side walls forming an internal blade cavity for holding a blade, at least a portion of the blade holding compartment is designed to be situated within the space of the handle during a folded position; and a blade release device comprises a blade lock and a button wedge, and the blade lock comprises at least one indentation situated in between at least two protrusions, and the protrusions are designed to contact and secure the blade within the blade cavity of the blade holding compartment, and the button wedge comprises a button connected to a wedge, and the wedge is designed to be situated within and moveable about a space created by the indentation of the blade lock, and the button is designed to be slidably moved to allow the wedge to engage the blade lock and create space between the blade and the protrusions of the blade lock to thereby release the blade.

In another embodiment, the blade lock and at least a portion of the button wedge are situated within the internal blade cavity. In yet another embodiment, the knife further comprises an interchangeable blade having at least one side with a sharp edge for cutting, and at least a portion of the blade is situated within the blade cavity of the blade holding compartment and a portion of the blade is situated outside of the blade holding compartment to expose at least a portion of the sharp edge of the blade.

In still another embodiment, the knife further comprises a device for securing the blade within the blade cavity of the blade holding compartment. In yet another embodiment, the handle comprises top and bottom ends and the blade holding compartment comprises top and bottom ends. In still yet another embodiment, the top end of the handle is pivotally connected to the bottom end of the blade holding compartment.

In a further embodiment, the button wedge is moved in an upward vertical direction to allow the wedge to engage the blade lock and thereby release the blade. In another further embodiment, the button wedge is moved in a downward vertical direction to allow the wedge to engage the blade lock and thereby release the blade. In yet a further embodiment, the button wedge is moved in a sideways horizontal direction to allow the wedge to engage the blade lock and thereby release the blade.

In still a further embodiment, the blade holding compartment has at least one aperture and an external surface, and the aperture leads from the external surface to the internal blade cavity. In still yet a further embodiment, the button of the button wedge is situated adjacent the external surface of the blade holding compartment and is designed to fit within the aperture of the blade holding compartment.

In another embodiment, the blade release device comprises at least two lock return springs. In a further embodiment, the blade lock has opposing sides and comprises at least two cavities for retaining the lock return springs, and the cavities are situated on the opposing side of the protrusions.

In another further embodiment, the present invention provides for a folding utility knife, the knife comprising: a handle pivotally connected to a blade holding compartment, and the handle comprising top and bottom ends and at least two side walls forming an internal cavity, and the cavity of the handle is designed to encase at least a portion of the blade holding compartment during a folded position, and the blade holding compartment comprises top and bottom ends and at least two side walls forming an internal blade cavity for holding a blade; and a blade release device comprises a blade lock and a button wedge, and the blade lock comprises at least one protrusion situated in between at least two indentions, and the protrusion is designed to contact and secure the blade within the blade cavity of the blade holding compartment, the button wedge comprises a button connected to a wedge, and the wedge comprises at least two prongs, and the prongs are designed to be situated within and moveable about a space created by the indentations of the blade lock, and the button is designed to be slidably moved to allow the prongs of the wedge to engage the blade lock and create space between the blade and the protrusion of the blade lock to thereby release the blade.

In another embodiment, the blade release device comprises at least one lock return spring. In still another embodiment, the blade lock comprises at least one cavity for retaining the lock return spring, and the cavity is situated on the opposing side of the protrusion.

In still another embodiment, the present invention relates to a folding utility knife, the knife comprises: a handle comprising at least two side walls forming an internal space; a blade holding compartment pivotally connected to the handle, and the blade holding compartment comprises at least two side walls forming an internal blade cavity, at least a portion of the blade holding compartment is designed to be situated within the space of the handle during a folded position; at least one interchangeable blade having at least one side with a sharp edge for cutting, at least a portion of the blade is situated within the blade cavity of the blade holding compartment and a portion of the blade is situated outside of the blade holding compartment to expose at least a portion of the sharp edge of the blade; and a blade release device comprising a blade lock and a button wedge, and the blade lock comprises at least one indentation and at least one protrusion, the protrusion is designed to contact and secure the blade within the blade cavity of the blade holding compartment, and the button wedge comprises a button connected to a wedge, the wedge is designed to be situated within and moveable about a space created by the indentation of the blade lock, and the button is designed to be slidably moved to allow the wedge to engage the blade lock and create space between the blade and the protrusion of the blade lock to thereby release the blade.

In yet another embodiment, the blade release device comprises at least one lock return spring. In still yet another embodiment, the blade lock comprises at least one cavity for retaining the lock return spring, and the cavity is situated on the opposing side of the protrusion.

### BRIEF DESCRIPTION OF THE DRAWINGS:

The accompanying drawings are included to provide a further understanding of the present invention. These drawings are incorporated in and constitute a part of this specification, illustrate one or more embodiments of the present invention and together with the description, serve to explain the principles of the present invention.

FIGS. 1a-c are perspective views of the folding utility knife of the present invention showing how the blade release mechanism functions;

FIGS. 2a-d are cutaway views showing the blade holding compartment with the blade release device;

FIG. 3 is a perspective view of one of the embodiments of the blade release device; and

FIG. 4 is a perspective view of another embodiment of the blade release device.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION:

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

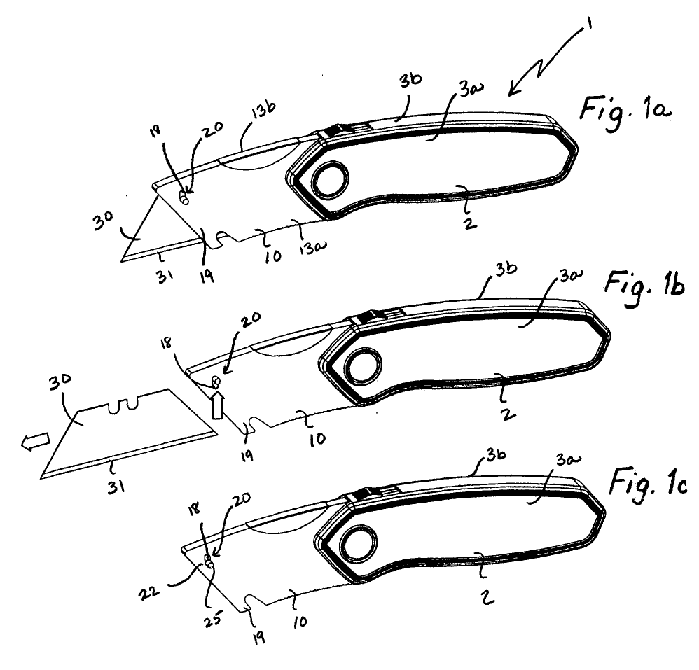

FIGS. 1a-c illustrate the blade release device 20 in the folding utility knife 1 of the present invention. The knife 1 comprises a handle 2, a blade holding compartment 10, at least one interchangeable blade 30 and a blade release device 20. The handle 2 comprises at least two side walls, 3a and b respectively, forming an internal space 4 (not shown). The blade holding compartment 10 is pivotally connected to the handle 2, and the blade holding compartment 10 comprises at least two side walls, 13a and b respectively, forming an internal blade cavity 14. At least a portion of the blade holding compartment 10 is designed to be situated within the space 4 of the handle 2 during a folded position.

The blade 30 has at least one side with a sharp edge 31 for cutting, and at least a portion of the blade 30 is situated within the blade cavity 14 of the blade holding compartment 10 and a portion of the blade 30 is situated outside of the blade holding compartment 10 to expose at least a portion of the sharp edge 31 of the blade 30.

The blade release device 20 comprises a blade lock 21 (not shown) and a button wedge 22, and the blade lock 21 comprises at least one indentation 23 and at least one protrusion 24. The protrusion 24 is designed to contact and secure the blade 30 within the blade cavity 14 of the blade holding compartment 10. The button wedge 22 comprises a button 25 connected to a wedge 26 (not shown), and the wedge 26 is designed to be situated within and moveable about a space 27 created by the indentation 23 of the blade lock 21. The button 25 is designed to be slidably moved to allow the wedge 26 to engage the blade lock 21 and create space between the blade 30 and the protrusion 24 of the blade lock 21 to thereby release the blade 30.

The blade release device 20 comprises at least one lock return spring 40 (not shown) and the blade lock 21 comprises at least one cavity 28 (not shown) for retaining the lock return spring 40, and the cavity 14 is situated on the opposing side of the protrusion 24.

The blade holding compartment 10 has at least one aperture 18 and an external surface 19 and the aperture 18 leads from the external surface 19 to the internal blade cavity 14. The button 25 of the button wedge 22 is situated adjacent the external surface 19 of the blade holding compartment 10 and the button 25 is designed to fit within the aperture 18 of the blade holding compartment 10.

FIG. 1a shows the knife 1 in an unfolded position with the blade 30 secured to the blade holding compartment 10. FIG. 1b illustrates the upward movement of the button 25 of the button wedge 22 which creates space between the blade 30 and the protrusion 24 of blade lock 21 which allow for the release and removal of the blade 30. FIG. 1c shows the blade holding compartment 10 of the knife 1 without any blade 30.

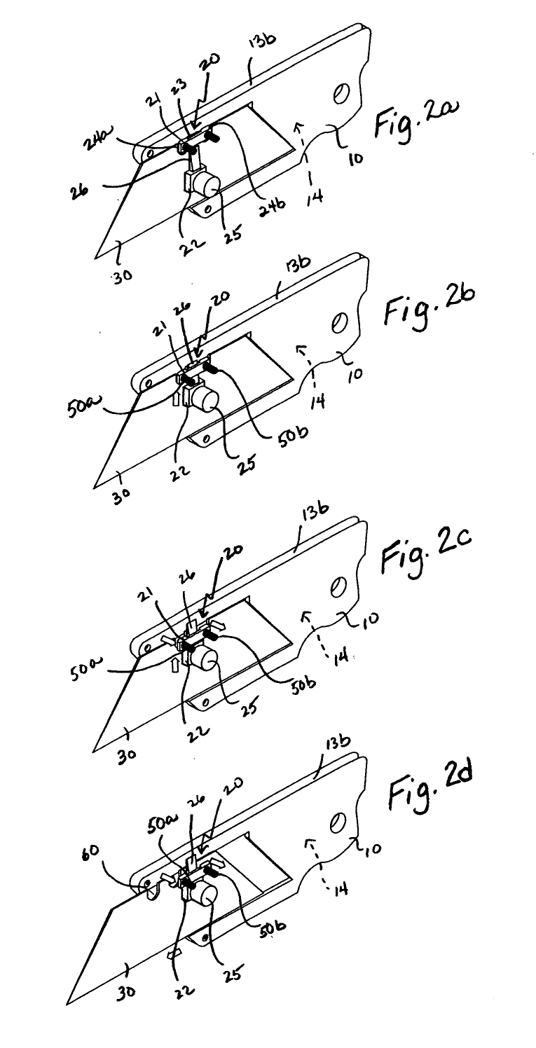

FIGS. 2a-d show cutaway views of the blade holding compartment 10 and the blade release device 20. The blade holding compartment 10 comprises at least two side walls, 13a and b, forming an internal blade cavity 14 for holding a blade 30; and a blade release device 20. The blade release device 20 comprises a blade lock 21 and a button wedge 22. The blade lock 21 comprises at least one indentation 23 situated in between at least two protrusions, 24a and b, and the protrusions, 24a and b, are designed to contact and secure the blade 30 within the blade cavity 14 of the blade holding compartment 10. The button wedge 22 comprises a button 25 connected to a wedge 26. The wedge 26 is designed to be situated within and moveable about a space 27 created by the indentation 23 of the blade lock 21, and the button 25 is designed to be slidably moved to allow the wedge 26 to engage the blade lock 21 and create space between the blade 30 and the protrusions, 24a and b, of the blade lock 21 to thereby release the blade 30.

The blade lock 21 and at least a portion of the button wedge 22 are situated within the internal blade cavity 14. The blade holding compartment 10 of the knife 1 further comprises a device 60 for securing the blade 30 within the blade cavity 14 of the blade holding compartment 10.

The blade release device 20 comprises at least two lock return springs, 50a and b respectively. The blade lock 20 has opposing sides and comprises at least two cavities, 51a and b respectively, for retaining the lock return springs, 50a and b, and the cavities, 51a and b, are situated on the opposing side of the protrusions, 24a and b.

FIG. 2a shows the blade secured into the internal cavity 14 of the blade holding compartment 10. The springs, 50a and b, are in an extended position. FIG. 2b-d illustrate how the button 25 of the button wedge 22 is moved in an upward vertical direction to allow the wedge 26 to engage the blade lock 21 and thereby release the blade 30. The movement of the wedge 26 into the blade lock 21 compresses the springs, 50a and b.

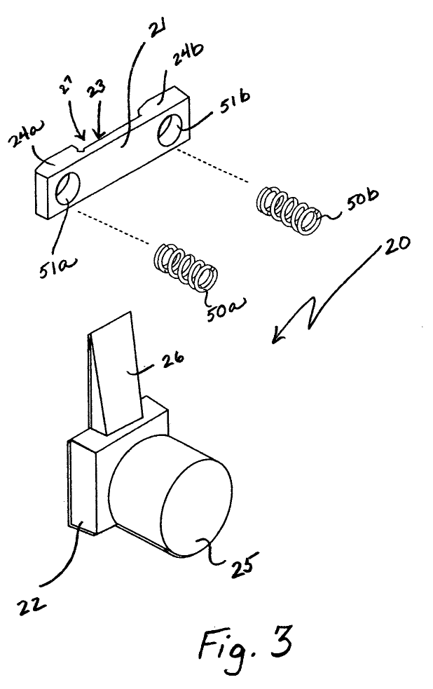

FIG. 3 shows one embodiment of blade release device 20. This one prong embodiment comprises a blade lock 21 and a button wedge 22. The blade lock 21 comprises at least one indentation 23 situated in between at least two protrusions, 24a and b, and the protrusions, 24a and b, are designed to contact and secure the blade 30 within the blade cavity 14 of the blade holding compartment 10. The button wedge 22 comprises a button 25 connected to a wedge 26. The wedge 26 is designed to be situated within and moveable about a space 27 created by the indentation 23 of the blade lock 21, and the button 25 is designed to be slidably moved to allow the wedge 26 to engage the blade lock 21 and create space between the blade 30 and the protrusions, 24a and b, of the blade lock 21 to thereby release the blade 30.

The blade release device 20 in this embodiment comprises at least two lock return springs, 50a and b respectively. The blade lock 20 has opposing sides and comprises at least two cavities, 51a and b respectively, for retaining the lock return springs, 50a and b, and the cavities, 51a and b, are situated on the opposing side of the protrusions, 24a and b.

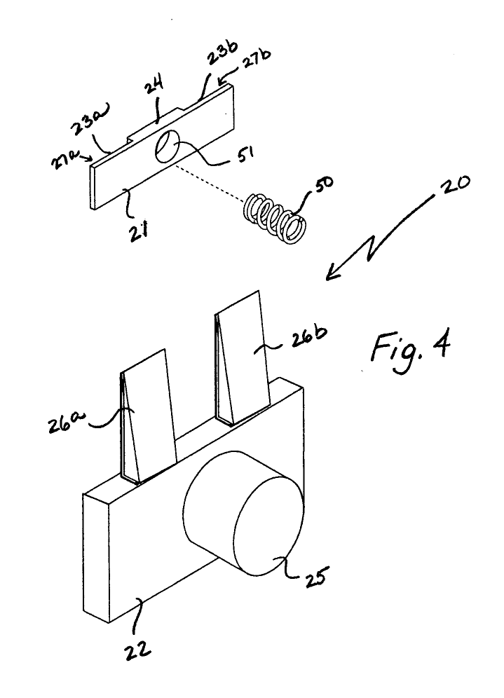

FIG. 4 illustrates the two prong embodiment of the blade release device 20 of the present invention. This two prong embodiment comprises a blade lock 21 and a button wedge 22. The blade lock 21 comprises at least one protrusion 24 situated in between two indentations, 23a and b respectively. The protrusion 24 is designed to contact and secure the blade 30 within the blade cavity 14 of the blade holding compartment 10. The button wedge 22 comprises a button 25 connected to at least two wedges, 26a and b respectively. The two wedges, 26a and b, are designed to be situated within and moveable about two spaces, 27a and b, created by the indentations, 23a and b, of the blade lock 21, and the button 25 is designed to be slidably moved to allow the wedges, 26a and b, to engage the blade lock 21 and create space between the blade 30 and the protrusion 24 of the blade lock 21 to thereby release the blade 30.

The blade release device 20 in this embodiment comprises at least one lock return spring 50. The blade lock 20 comprises at least one cavity 51 for retaining the lock return spring 50 and the cavity 51 are situated on the opposing side of the protrusion 24.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A folding utility knife comprising:
a handle comprising at least two side walls forming an internal space;
a blade holding compartment pivotally connected to said handle, said blade holding compartment comprising at least two side walls forming an internal blade cavity for holding a blade, at least a portion of said blade holding compartment designed to be situated within said space of said handle during a folded position; and
a blade release device comprising a blade lock and a button wedge, said blade lock comprising at least one indentation situated in between at least two protrusions, said protrusions designed to contact and secure the blade within said blade cavity of said blade holding compartment, said button wedge comprising a button connected to a wedge, said wedge is designed to be situated within and moveable about a space created by said indentation of said blade lock, said button is designed to be slidably moved to allow said wedge to engage said blade lock and create space between the blade and said protrusions of said blade lock to thereby release the blade.

2. The knife of claim 1 wherein said blade lock and at least a portion of said button wedge is situated within said internal blade cavity.

3. The knife of claim 1 further comprising an interchangeable blade having at least one side with a sharp edge for cutting, at least a portion of said blade being situated within said blade cavity of said blade holding compartment and a portion of the blade being situated outside of the blade holding compartment to expose at least a portion of the sharp edge of said blade.

4. The knife of claim 1 further comprising a device for securing the blade within said blade cavity of said blade holding compartment.

5. The knife of claim 1 wherein said handle comprises top and bottom ends and said blade holding compartment comprises top and bottom ends.

6. The knife of claim 5 wherein said top end of said handle is pivotally connected to said bottom end of said blade holding compartment.

7. The knife of claim 1 wherein said button wedge is moved in an upward vertical direction to allow said wedge to engage said blade lock and thereby release the blade.

8. The knife of claim 1 wherein said button wedge is moved in a downward vertical direction to allow said wedge to engage said blade lock and thereby release the blade.

9. The knife of claim 1 wherein said button wedge is moved in a sideways horizontal direction to allow said wedge to engage said blade lock and thereby release the blade.

10. The knife of claim 1 wherein said blade holding compartment has at least one aperture and an external surface, said aperture leading from said external surface to said internal blade cavity.

11. The knife of claim 10 wherein said button of said button wedge is situated adjacent said external surface of said blade holding compartment and designed to fit within said aperture of said blade holding compartment.

12. The knife of claim I wherein said blade release device comprises at least two lock return springs.

13. The knife of claim 12 wherein said blade lock has opposing sides and comprises at least two cavities for retaining said lock return springs, said cavities being situated on the opposing side of said protrusions.

14. A folding utility knife comprising:
a handle pivotally connected to a blade holding compartment, said handle comprising top and bottom ends and at least two side walls forming an internal cavity, said cavity of said handle designed to encase at least a portion of said blade holding compartment during a folded position, said blade holding compartment comprising top and bottom ends and at least two side walls forming an internal blade cavity for holding a blade; and
a blade release device comprising a blade lock and a button wedge, said blade lock comprising at least one protrusion situated in between at least two indentions, said protrusion designed to contact and secure the blade within said blade cavity of said blade holding compartment, said button wedge comprising a button connected to a wedge, said wedge comprises at least two prongs, said prongs are designed to be situated within and moveable about a space created by said indentations of said blade lock, said button is designed to be slidably moved to allow said prongs of said wedge to engage said blade lock and create space between the blade and said protrusion of said blade lock to thereby release the blade.

15. The knife of claim 14 wherein said blade lock and at least a portion of said button wedge are situated within said internal cavity of said blade holding compartment.

16. The knife of claim 14 further comprising an interchangeable blade having at least one side with a sharp edge for cutting, at least a portion of said blade being situated within said blade cavity of said blade holding compartment and a portion of the blade being situated outside of the blade holding compartment to expose at least a portion of the sharp edge of said blade.

17. The knife of claim 16 further comprising a device for securing the blade with said blade cavity of said blade holding compartment.

18. The knife of claim 14 wherein said button wedge is moved in an upward vertical direction to allow said wedge to engage said blade lock and thereby release the blade.

19. The knife of claim 14 wherein said button wedge is moved in a downward vertical direction to allow said wedge to engage said blade lock and thereby release the blade.

20. The knife of claim 14 wherein said button wedge is moved in a horizontal direction to allow said wedge to engage said blade lock and thereby release the blade.

21. The knife of claim 14 wherein said blade release device comprises at least one lock return spring.

22. The knife of claim 21 wherein said blade lock comprises at least one cavity for retaining said lock return spring, said cavity being situated on the opposing side of said protrusion.

23. A folding utility knife comprising:
a handle comprising at least two side walls forming an internal space;
a blade holding compartment pivotally connected to said handle, said blade holding compartment comprising at least two side walls forming an internal blade cavity, at least a portion of said blade holding compartment designed to be situated within said space of said handle during a folded position;
at least one interchangeable blade having at least one side with a sharp edge for cutting, at least a portion of said blade being situated within said blade cavity of said blade holding compartment and a portion of the blade being situated outside of the blade holding compartment to expose at least a portion of the sharp edge of said blade; and
a blade release device comprising a blade lock and a button wedge, said blade lock comprising at least one indentation and at least one protrusion, said protrusion designed to contact and secure the blade within said blade cavity of said blade holding compartment, said button wedge comprising a button connected to a wedge, said wedge is designed to be situated within and moveable about a space created by said indentation of said blade lock, said button is designed to be slidably moved to allow said wedge to engage said blade lock and create space between the blade and said protrusion of said blade lock to thereby release the blade.

24. The knife of claim 23 wherein said blade release device comprises at least one lock return spring.

25. The knife of claim 24 wherein said blade lock comprises at least one cavity for retaining said lock return spring, said cavity being situated on the opposing side of said protrusion.
